(19) United States
(12) Patent Application Publication
(10) Pub. No.: US 2004/0181526 A1
(43) Pub. Date: Sep. 16, 2004

(54) Robust system for interactively learning a record similarity measurement

(75) Inventors: Douglas R. Burdick, Ithaca, NY (US); Robert J. Szczerba, Endicott, NY (US)

Correspondence Address: TAROLLI, SUNDHEIM, COVELL & TUMMINO LLP, 1111 LEADER BLDG., CLEVELAND, OH, 44114, US

(73) Assignee: Lockheed Martin Corporation

(21) Appl. No.: 10/385,828

(22) Filed: Mar. 11, 2003

(51) Int. Cl. G06F 17/30

(52) U.S. Cl. 707/6; 707/3

(57) ABSTRACT

A system learns a record similarity measurement. The system includes a set of record clusters. Each record in each cluster may have a list of fields and data contained in each field. The system may further include a predetermined threshold score for two of the records in one of the clusters to be considered similar and at least one decision tree constructed from a portion of the set of clusters. The decision tree encodes rules for determining a field similarity score of a related set of fields. The system may further include an output set of record pairs that are determined to be duplicate records. The output set of record pairs may have a record similarity score greater than or equal to the predetermined threshold score.

### FIELD OF THE INVENTION

The present invention relates to a system for interactively learning, and more particularly, to a system for interactively learning a record similarity measurement.

### BACKGROUND OF THE INVENTION

In today's information age, data is the lifeblood of any company, large or small, federal or commercial. Data is gathered from a variety of different sources in a number of different formats or conventions. Examples of data sources would be: customer mailing lists, call-center records, sales databases, etc. Each record contains different pieces of information (in different formats) about the same entities (customers in this case). Data from these sources is either stored separately or integrated together to form a single repository (i.e., data warehouse or data mart). Storing this data and/or integrating it into a single source, such as a data warehouse, increases opportunities to use the burgeoning number of data-dependent tools and applications in such areas as data mining, decision support systems, enterprise resource planning (ERP), customer relationship management (CRM), etc.

The old adage “garbage in, garbage out” is directly applicable to this situation. The quality of analysis performed by these tools suffers dramatically if the data analyzed contains redundancies, incorrect, or inconsistent values. This “dirty” data may be the result of a number of different factors including, but certainly not limited to, the following: spelling (phonetic and typographical) errors, missing data, formatting problems (wrong field), inconsistent field values (both sensible and non-sensible), out of range values, synonyms or abbreviations, etc. Because of these errors, multiple database records may inadvertently be created in a single data source relating to the same object (i.e., duplicate records) or records may be created which don't seem to relate to any object (i.e., “garbage” records). These problems are aggravated when attempting to merge data from multiple database systems together, as data warehouse and/or data mart applications. Properly reconciling records with different formats becomes an additional issue here.

A data cleansing application may use clustering and matching algorithms to identify duplicate and “garbage” records in a record collection. Each record may be divided into fields, where each field stores information about an attribute of the entity being described by the record. Clustering refers the step where groups of records likely to represent the same entity are created. This group of records is called a cluster. If constructed correctly, each cluster contains all records in a database actually corresponding to a single unique entity. A cluster may also contain some other records that correspond to other entities, but are similar enough to be considered. Preferably, the number of records in the cluster is very close to the number of records that actually correspond to the single entity for which the cluster was built. FIG. 1 illustrates an example of four records in a cluster with similar characteristics.

Matching is the process of identifying the records in a cluster that actually refer to the same entity. Matching involves searching the clusters with an application specific set of rules and uses a search algorithm to match elements in a cluster to a unique entity. In FIG. 2, the three indicated records from FIG. 1 likely correspond to the same entity, while the fourth record from FIG. 1 has too many differences and likely represents another entity.

Determining if two records are duplicates may involve the performance of a similarity test to quantify “how similar” the records are to each other. Since this similarity test is computationally intensive, it is only performed on records that are placed in the same cluster. If the similarity score is greater than a certain threshold value, the records are considered duplicates (i.e., the two records describe the same entity, etc.). Otherwise, the records are considered non-duplicates (i.e., they describe different entities, etc.). The record similarity score is computed by computing a similarity score between each pair of corresponding field values separately and then combining these field similarity scores together.

Decision trees classify “comparison instances” by sorting them down the tree from the root to some leaf node, which provides the classification of the comparison instance. Each node in the tree may specify a test on some attribute of the comparison instance, and each branch descending from that node may correspond to one of the possible values for this attribute. A comparison instance is classified by starting at the root node of the tree, testing the attribute specified by this node, then moving down the tree branch corresponding to the value of the attribute in the given example. This process is then repeated for the subtree rooted at the new node. The process terminates at a leaf node, where the comparison instance is assigned a classification label by the decision tree.

There are many different ways to create a decision tree from a set of training data. The training data may be comparison instances with classification labels assigned to them, usually by a human user. The basic algorithm (and its many variants) learns decision trees by constructing them in a top-down manner, beginning with the question “which attribute should be tested at the root of the tree?” To answer this question, each attribute is evaluated using a statistical test to determine how well it alone classifies the training examples. The best attributes may be selected and used as a test for the root node of the tree. A descendant may be created for each possible value (or range of values) of this attribute, and the training examples are sorted to the appropriate descendant node. The entire process may be repeated using the training examples associated with each descendant node to select the best attribute to test at that point in the tree.

Conventional systems for matching potentially duplicate records generally use a static, fixed approach for all records in the collection. These systems attempt to assign a globally optimal set of weights to the field similarity values when combining them together to calculate a record similarity score. For all records in the collection, this matching function is a simple linear combination of the field similarity values, calculated by a formula such as the formula of FIG. 8.

Conventional systems do not provide a mechanism for interactively learning (from user feedback) ways to dynamically adjust a record similarity function to increase the accuracy of a matching step in a data cleansing process. Further, conventional systems do not attempt to minimize the amount of manual labeling of records that a user must perform.

### SUMMARY OF THE INVENTION

A system in accordance with the present invention learns a record similarity measurement. The system may include a set of record clusters. Each record in each cluster has a list of fields and data contained in each field. The system may further include a predetermined threshold score for two of the records in one of the clusters to be considered similar. The system may still further include at least one decision tree constructed from a predetermined portion of the set of clusters. The decision tree encodes rules for determining a field similarity score of a related set of fields. The system may further yet include an output set of record pairs that are determined to be duplicate records. The output set of record pairs each has a record similarity score determined by the field similarity scores. The output record pairs each have a record similarity score greater than or equal to the predetermined threshold score.

A method in accordance with the present invention learns a record similarity measurement. The method may comprise the steps of: providing a set of record clusters, each record in each cluster having a list of fields and data contained in each field; providing a predetermined threshold score for two of the records in one of the clusters to be considered similar; providing at least one decision tree constructed from a portion of the set of clusters, the decision tree encoding rules for determining a field similarity score of a related set of fields; determining a record similarity score from the field similarity scores; and outputting a set of record pairs that are determined to be duplicate records, the output set of record pairs having a record similarity score greater than or equal to the predetermined threshold score.

A computer program product in accordance with the present invention interactively learns a record similarity measurement. The may include an input set of record clusters. Each record in each cluster has a list of fields and data contained in each field. The product may further include a predetermined input threshold score for two of the records in one of the clusters to be considered similar. The product may still further include an input decision tree constructed from a portion of the set of clusters. The decision tree encodes rules for determining a field similarity score of a related set of fields. The product may further yet include an output set of record pairs that are determined to be duplicate records. The output set of record pairs has a record similarity score greater than or equal to the predetermined threshold score.

### BRIEF DESCRIPTION OF THE DRAWINGS

The foregoing and other advantages and features of the present invention will become readily apparent from the following description as taken in conjunction with the accompanying drawings, wherein:

FIG. 1 is a schematic representation of an example process for use with the present invention;

FIG. 2 is a schematic representation of another example process for use with the present invention;

FIG. 3 is a selection of sample data for use with the present invention;

FIG. 4 is a schematic representation of part of an example system in accordance with the present invention;

FIG. 5 is a schematic representation of another part of an example system in accordance with the present invention;

FIG. 6 is a schematic representation of an example system in accordance with the present invention;

FIG. 7 is a schematic representation of another example system in accordance with the present invention; and

FIG. 8 is a schematic representation of still another example process for use with the present invention.

### DETAILED DESCRIPTION OF AN EXAMPLE EMBODIMENT

A system in accordance with the present invention includes a robust method for interactively learning a record similarity measurement function. Such a function may be used during the matching step of a data cleansing application to identify sets of database records actually referring to the same real-world entity.

After learning an initial record similarity function, the system may identify ambiguous and/or inconsistent cases that cannot be handled with a high degree of confidence. Based on these cases, the system may generate training examples to be presented to a human user. The input from an interactive learning session may be used to refine how a data cleansing application processes ambiguous cases during a matching step.

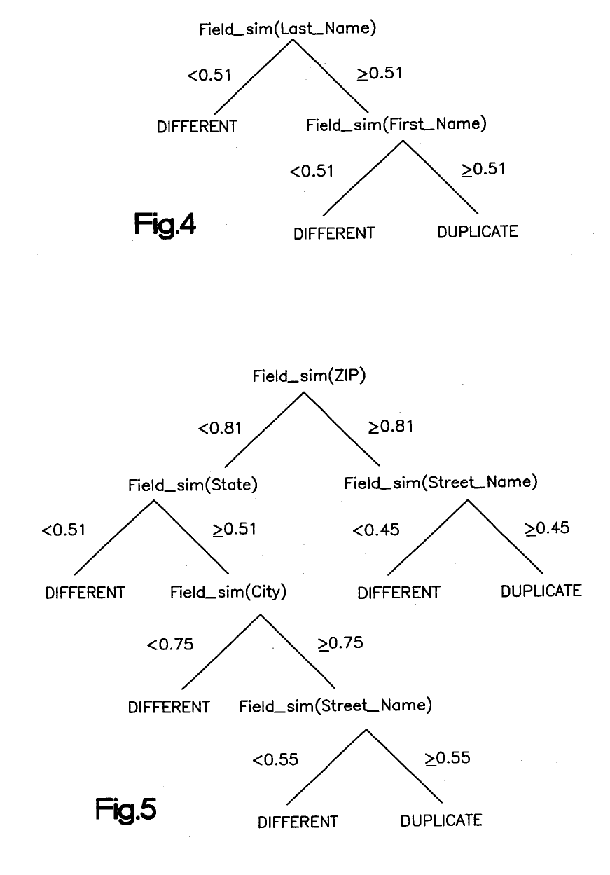

The system performs equally well with decision trees that are constructed by any method. Most of the variation in the decision tree construction methods comes from the nature of the statistical test used to select the appropriate test attribute. The system selects the attributes as the field similarity values for each pair of corresponding values. The classification labels assigned to each pair indicate whether the record pair is DUPLICATE (i.e., records refer to the same entity, etc.) or DIFFERENT (i.e., records refer to different entities, etc.). Examples of the types of decision trees generated and used by the system are illustrated in parts FIGS. 4 and 5.

During a matching step, the system may determine a numerical record similarity score for each pair of records. The determination may involve two steps: assigning the field similarity values for each pair of corresponding field values; and computing a record similarity score value by combining the field similarity values together. The method for calculating the field similarity values may be any conventional method.

The system in accordance with the present invention intelligently combines the field similarity scores together to generate a record similarity score. If the record similarity score for the record pair is greater than a certain threshold value, the records in the pair are considered duplicates. The system generates the record similarity function that will assign the similarity score to each pair of records in a cluster.

Preferably, record pairs will have a large number of high similarity values, since records from a cluster should contain a very close value for most fields. However, if there is more than one entity represented within the cluster, different arrays of similarity values will be associated with the cluster. One array may have many high similarity field values, while another may have low field similarity values.

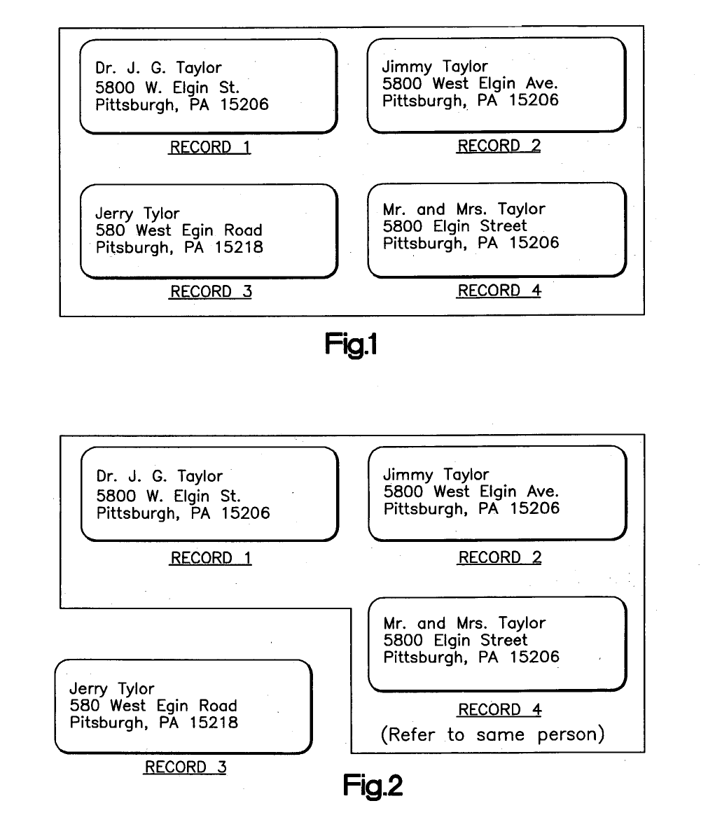

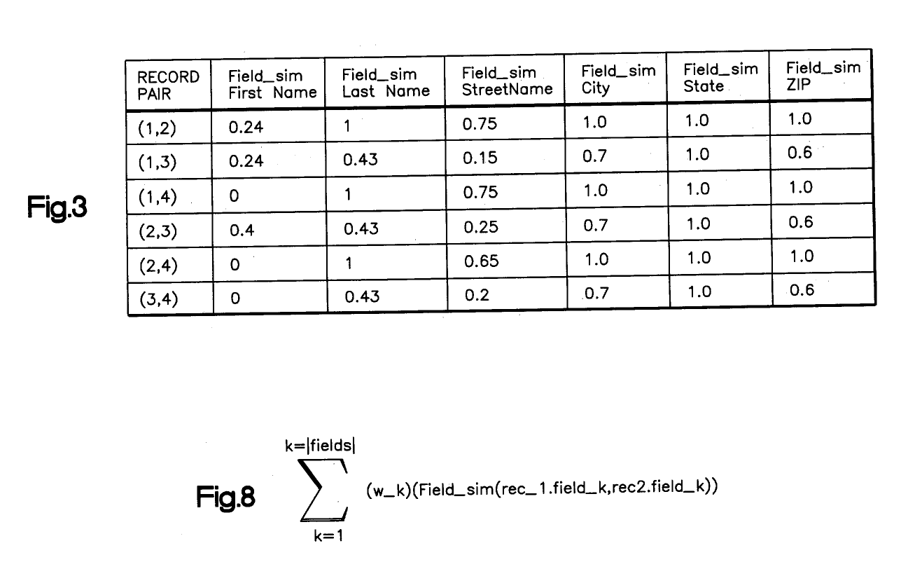

For example, the field similarity scores in FIG. 3 may be assigned to the 6 record pairs in the cluster from FIG. 1. (Note: The four records in the cluster of FIG. 1 may be paired 6 different ways producing 6 record pairs). Each row in FIG. 3 corresponds to a record pair, and each column corresponds to a field_sim value for each field pair of each record pair. The field_sim values indicate Record 3 probably doesn't belong with Records 1, 2, and 4. The record pairs (1,2) (1,4) and (2,4) all share a number of high field similarity values, while (1,3), (2,3), and (3,4) have a number of low field similarity values. This indicates that record 3 is not “similar” to the other records, while Records 1, 2 and 4 are “similar” to each other. Thus, a matching step of a data cleansing application will likely determine that the cluster from FIG. 1 should be split into two clusters. FIG. 2 illustrates this split.

Since clusters are typically built using identical clustering procedures (i.e., every cluster was built using the same clustering rules), matching in other clusters should follow similar patterns (i.e., a cluster with records for multiple entities will have similar patterns to the field_sim values for record pairs of that cluster). Thus, accurately learning the rules that describe the record similarity function, while limiting the amount of data that a user has to manually inspect, would be beneficial.

The system selects the record pairs that provide the most information about the record similarity function for inspection by a user. During an interactive session with a user, the system may present such “interesting” record pairs to a user and receive feedback from the user. Based on this feedback, the system may refine the similarity function to increase the overall accuracy of a matching step of a data cleansing application.

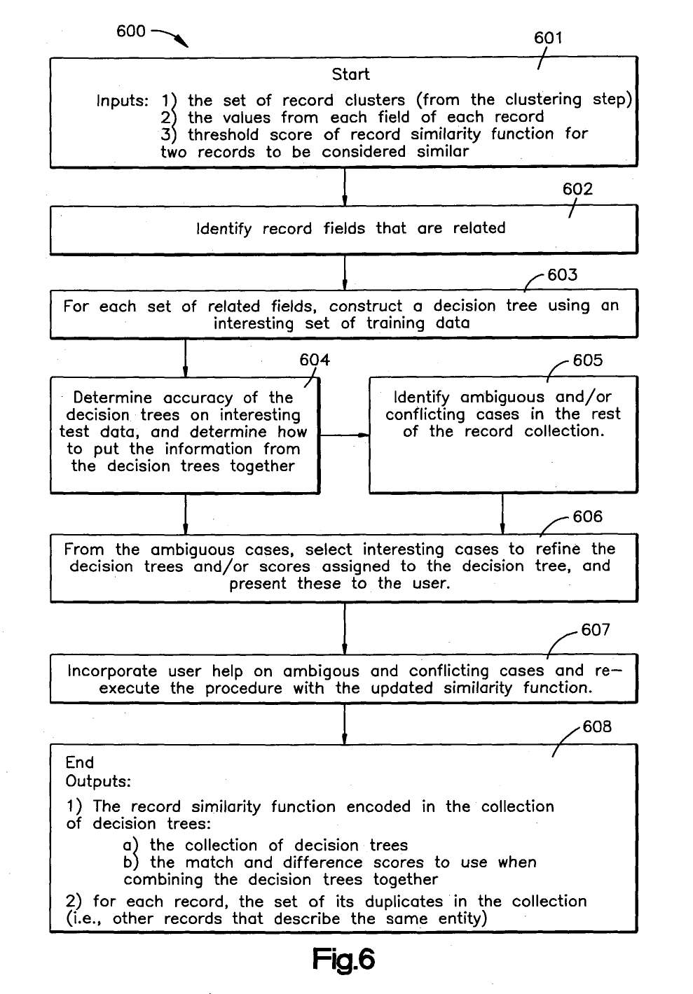

As illustrated in FIG. 6, an example system 600 in accordance with the present invention may include the following steps. In step 601 the system 600 inputs a set of record clusters from a clustering step, the values from each field of each record, and a threshold score of a record similarity function for two records to be considered “similar”. Following step 601, the system 600 proceeds to step 602. In step 602, the system 600 identifies record fields that are related. In step 602, a user may manually identify sets of record fields that are related.

The system 600 may also include a data mining process to identify patterns and correlations between record fields, which may guide the user in identifying these related sets. For example, a customer address may have six data fields: First_Name, Last_Name, Street_Name, City, State and ZIP. For this example, there are likely two sets of related fields with the First_Name and Last_Name fields associated together, and the Street_Name, City, State and ZIP fields associated together. If all the fields are related, or if the user is unable to separate the fields into sets, then all of the fields will be placed in a single related set. Additionally, the sets of related fields may not be disjoint (i.e., a field may be in more than one related set, etc.).

This dividing of the records into groups of related fields by step 602 of the system 600 insures that the system does not learn rules based on spurious patterns that have little value to the task of identifying duplicate records. For example, a rule like First_Name being related to ZIP code may be a valid pattern in the training data, but is not very useful for identifying duplicate records in a real world case.

Following step 602, the system 600 proceeds to step 603. In step 603, the system 600, for each set of related fields, constructs a decision tree using an “interesting” set of training data. The best initial training set will typically be record pairs that likely contain examples of the subtleties in the similarity function for identifying duplicate and non-duplicate record pairs. If there exists such training data, or if the user has the ability to select such record pairs, then this input may be used.

If such training data does not exist, the system 600 may select clusters from the record collection as training data likely to contain examples of both duplicate and non-duplicate record pairs. For example, the system 600 may identify clusters that appear to have two or more distributions of field_sim values for the record pairs. A good candidate cluster for training may be the example cluster of FIG. 3, with some record pairs having very high field_sim values for all fields, and other pairs having very low field_sim values for all fields. The system 600 may present these type of clusters to a user. The user may then manually identify the duplicate and non-duplicate record pairs in these clusters. Based on this, the system 600 may assign the labels DUPLICATE or DIFFERENT to each record pair in these clusters.

The system 600 may then construct a decision tree from the training data. The system 600 will construct a separate decision tree for each set of related record fields. The system 600 may utilize any method for creating the decision trees (e.g., variants of ID3, C4.5, CART, etc.). The system 600 is only limited in that the split attribute at each internal node may only involve one or more of the fields from the set of related fields for which the tree is constructed.

As illustrated in FIGS. 4 and 5, each internal node in the example tree specifies a test of one of the field_sim values in a record pair, and each leaf node assigns the label DUPLICATE (i.e., the records in the pair describe the same entity, etc.) or DIFFERENT (i.e., the records in the pair describe different entities, etc.).

The output of step 603 is a decision tree for each group of record fields. Each decision tree encodes the rules that describe similar records, with each rule governing only a set of related fields. The example decision trees in FIGS. 4 and 5 correspond to the example sets of related fields from step 601. The First_Name and Last_Name fields are associated together, and the Street_Name, City, State and ZIP fields are associated together.

Following step 603, the system 600 proceeds to step 604. In step 604, the system 600 determines the accuracy of the decision trees regarding “interesting” test data. Further, in step 604, the system 600 determines how to combine the information from the decision trees. The system 600 determines the accuracy of each decision tree by selecting a set of test data from the record collection.

In step 604, the system 600 randomly selects clusters from the record collection that were not included in the training data. The system 600 presents the record pairs in these clusters to the user, along with the label assigned to each record pair by each of the decision trees. This allows the user to correct any incorrect labels and record the accuracy rate for each decision tree acting on the test data (i.e., how often the decision tree assigned the correct label to the record pair, etc.).

Once the accuracy of each decision tree has been determined, the system 600 combines the results from the separate trees to compute a similarity score for the entire record pair. If the similarity score is greater than a certain predetermined threshold value, the records are considered duplicates.

The system 600 may combine the results from the separate decision trees by assigning a match_score to each record pair in each decision tree. The match_score measures the weight in the similarity score of a DUPLICATE label of a record pair in a decision tree.

Similarly, the system 600 may assign a difference_score to each record pair in each decision tree. The difference_score is a penalty to be subtracted from the similarity score if the decision tree assigns the label DIFFERENT to the record pair.

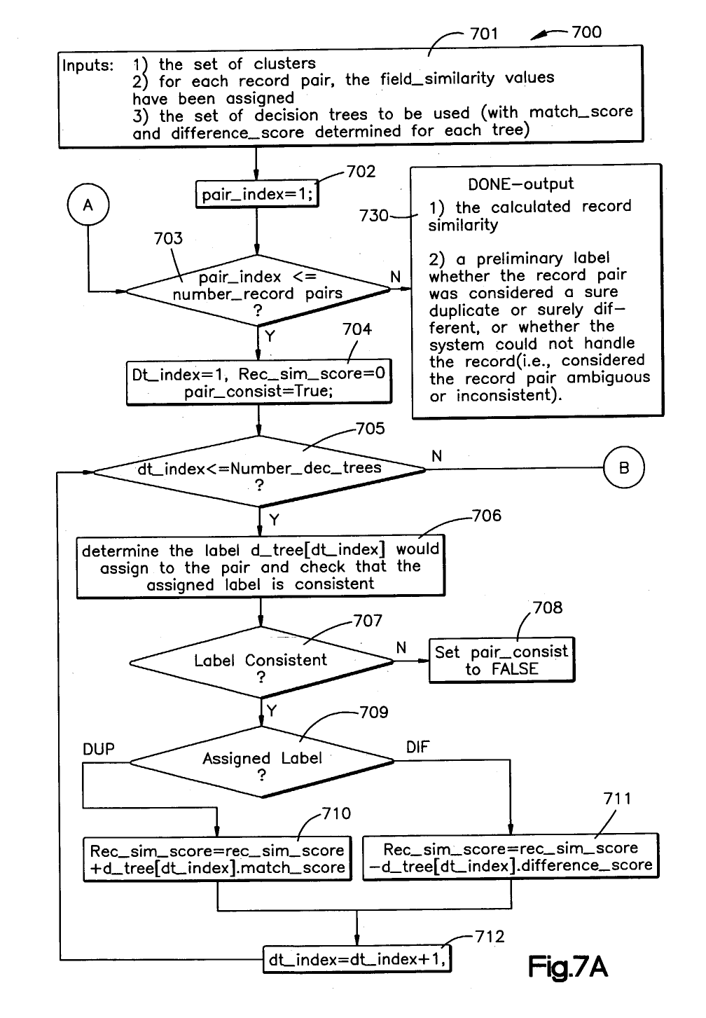

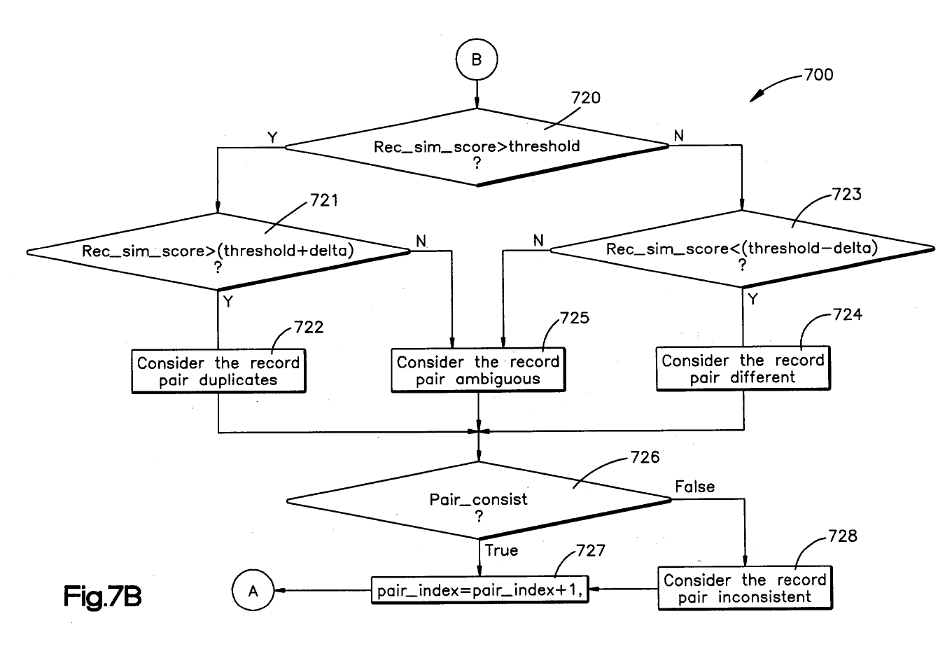

The match_score and difference_score may be assigned by a user or derived from the decision tree's accuracy regarding the test data (i.e., a lower false negative rate is translated to a higher difference_score; a lower false positive score translates to a higher match_score, etc.). Given the match_score and the difference_score for each record pair in each decision tree, the system 600 may combine the results for the separate decision trees together for each remaining record pair in the database, as illustrated in FIGS. 7A and 7B. FIGS. 7A and 7B illustrate steps 604 and step 605 integrated together.

Following step 604, the system 600 proceeds to step 605. In step 605, the system 600 identifies ambiguous and/or conflicting cases in the record collection. (Step 605 may alternatively be executed simultaneously with step 604, as illustrated in FIGS. 7A and 7B).

“Ambiguous” cases are cases that the system 600 cannot process with a high degree of confidence. These cases may be assigned similarity score with a value that is very close to the threshold value. In these cases, a slight fluctuation in the similarity score determines if the record pair is labeled similar or dissimilar. For these ambiguous cases, the system 600 may determine a delta range around the threshold value within which a case may be considered to be in an uncertainty region. The system 600 may further classify all record pairs as follows: all record pairs with similarity scores above (threshold+delta) are considered strongly duplicate; all record pairs with similarity scores below (threshold−delta) are considered strongly different; and all record pairs with similarity scores between (threshold−delta) and (threshold+delta) are considered ambiguous, thereby needing more information to properly classify these cases as duplicate or different.

“Inconsistent” cases occur when a decision tree assigns conflicting labels to a group of record pairs. For example, one decision tree may process three record pairs, as follows: (Record 1, Record 2)=>DUPLICATE; (Record 1, Record 3)=>DUPLICATE; and (Record 2, Record 3)=>DIFFERENT. For most applications, this would be inconsistent. If records 1, 2, and 3 all describe the same entity, then records 2 and 3 should also be considered as describing the same entity. This is a highly simplified example of an inconsistency. More information is needed to resolve these inconsistencies for the results of the matching step to be accurate.

Following step 604/605, the system 600 proceeds to step 606. In step 606, the system 600 selects “interesting” cases from the “ambiguous” cases to refine the decision trees and/or scores assigned to the decision trees. The system 600 presents these to a user. The interesting cases preferably are record pairs that best help the system 600 resolve the ambiguous and inconsistent cases. When the system 600 has more information about these cases (i.e., a correct user assigned label, etc.), the system may properly modify the similarity function to correctly process the remaining problem cases. The system 600 will then present these to a user and the user may manually assign the correct label to the record pair, DUPLICATE or DIFFERENT.

The system 600 may identify recurring patterns among the set of record examples given ambiguous similarity scores, then select a sampling of record pairs from this set for manual labeling by a user.

The system 600 may include identifying specific “trouble” leaves in one or more of the decision trees. These trouble leaves may be leaves that assign an incorrect label to a record pair very often. For example, a trouble leaf may assign the label DUPLICATE, but a majority of the record pairs assigned to that leaf should be assigned the label DIFFERENT. The system 600 may examine the conflicting label assignments to record pairs and/or the ambiguous record pair similarity scores.

The feedback on these cases may be incorporated into a record similarity function multiple ways. For example, the decision trees may be refined. The simplest refinement would be to change the labels of the offending leaves. Another refinement may be to replace one or more of the “trouble” leaf nodes with a new decision tree constructed for the examples associated with that leaf node. A candidate leaf node for such expansion may be one where a significant portion of the examples at the node receives a record similarity score in the ambiguous range. The steps for constructing each extension may include: selecting the training examples for building the extended decision tree (the training instances may be the original training examples and/or record pairs assigned non-ambiguous record similarity scores by the current function); selecting which attributes to include the extended decision tree (the pool of extra attributes that may be used to extend the tree will be the field similarity values that provide extra information; this will be the set of field sim values not used already to reach the leaf node and are in the set of related fields for which the tree was originally constructed); and constructing the extended decision tree (the decision tree construction method used to build the decision tree(s), with the training examples selected, and limit the pool of available decision attributes to the identified field_sim values; replace the leaf with the newly constructed tree).

The system 600 may also modify the weights assigned to each decision tree. Based on the user feedback, it may be most appropriate to change the match_score and/or the difference_score assigned to one or more of the decision trees.

Following step 606, the system 600 proceeds to step 607. In step 607, the system 600 incorporates user help on ambiguous and conflicting cases and reexecutes the procedure with the updated similarity function. The system 600 executes the matching process again for the ambiguous cases with the new, improved similarity measurements. The ambiguous cases will be assigned an improved similarity score based on the new set of decision trees, the weighted combination of field similarity scores, and threshold values. The system 600 may iterate any of the above-described steps as needed to further refine the similarity measurement.

Following step 607, the system 600 proceeds to step 608. In step 608, the system 600 outputs the record similarity function encoded in the collection of decision trees. This output includes the collection of decision trees and the match and/or difference scores to use when combining the decision trees together. In step 608, the system 600 further outputs, for each record, the set of its duplicates in the collection (i.e., other records that describe the same entity).

FIGS. 7A and 7B illustrate an example system 700 for performing step 605 of FIG. 6. In step 701, the system 700 inputs the set of clusters, the field_similarity values assigned for each record pair, and the set of decision trees (with match_score and difference_score determined for each decision tree). Following step 701, the system 700 proceeds to step 702. In step 702, the system 700 creates and initializes the variable pair_index to 1. Following step 702, the system 700 proceeds to step 703. In step 703, the system 700 compares pair_index to the total number of record pairs in all of the clusters (which is stored in the variable number_record_pairs). If pair_index is less than number_record_pairs, then there are still record pairs to be processed and the system 700 proceeds to step 704. Otherwise, all terms in the clustering rule have been evaluated and the system 700 proceeds to step 730. In step 730, the system 700 outputs the calculated record similarity score and a preliminary label whether the system considered the record pair surely a duplicate, surely different, or not processable by the system (i.e., the record pair is ambiguous or inconsistent, etc.).

In step 704, the system 700 creates and initializes the variables dt_index to 1, rec_sim_score to 0, and pair_consist to TRUE. The dt_index variable is used for iterating through the decision trees while calculating the record similarity score, which is stored in rec_sim_score; and pair_consist tracks whether the record pair is processed consistently by all of the decision trees. Following step 704, the system 700 proceeds to step 705.

In step 705, the system 700 compares dt_index to the total number of decision trees (which is stored in the variable number_dec_trees). If dt_index is less than number_dec_trees, then there are still decision trees to be processed and the system 700 proceeds to step 706. Otherwise, all terms in the clustering rule have been evaluated and the system 700 proceeds to step 720.

In step 706, the system 700 determines the label d_tree [dt_index] that the decision tree assigns to the record pair and determines whether the label is consistent with the labels assigned by the decision tree for other record pairs. Following step 706, the system 700 proceeds to step 707. In step 707, the system 700 determines whether the label is consistent. If the label is consistent, the system 700 proceeds to step 709. Otherwise, the system 700 proceeds to step 708. In step 708, the system 700 sets pair_consist to FALSE, indicating that the decision tree did not consistently process this record pair.

In step 709, if the label assigned by the decision tree is DUPLICATE, the system 700 proceeds to step 710. Otherwise, the label is DIFFERENT and the system 700 proceeds to step 711. In step 710, the system 700 adds the rec_sim_score to the match score d_tree [dt_index] for the decision tree that has just assigned the label to the record pair. Following step 710, the system 700 proceeds to step 712.

In step 711, the system 700 subtracts from the rec_sim_score the difference_score d_tree [dt_index] for the decision tree that has just assigned the label to the record pair. Following step 711, the system proceeds to step 712.

In step 712, the system 700 increments dt_index to signify that the system has concluded considering the current decision tree. Following step 712, the system 700 proceeds back to step 705.

In step 720 (from step 705), the system 700 determines whether the rec_sim_score is greater than the threshold value. If the rec sim_score is greater than the threshold value, the system 700 proceeds to step 721. If the rec_sim_score is not greater than the threshold value, the system 700 proceeds to step 723.

In step 721, the system 700 determines whether the rec_sim_score is greater than the threshold value plus a predetermined delta. If the rec_sim_score is greater than the threshold value plus delta, the system 700 proceeds to step 722. If the rec_sim_score is not greater than the threshold value plus delta, the system 700 proceeds to step 725. In step 722, the system 700 assigns the record pair a final label of sure duplicate. Following step 722, the system 700 proceeds to step 726.

In step 723, the system 700 determines whether the rec_sim_score is less than the threshold value minus delta. If the rec_sim_score is less than the threshold value minus delta, the system 700 proceeds to step 724. If the rec_sim_score is not less than the threshold value minus delta, the system 700 proceeds to step 725. In step 724, the system 700 assigns the record pair a final label of sure different. Following step 724, the system 700 proceeds to step 726.

In step 725, the system 700 assigns the record pair a final label of ambiguous (i.e., more information is needed to confidently classify this record pair, etc.). Following step 725, the system 700 proceeds to step 726.

In step 726, the system 700 checks the pair_consist flag to determine whether all decision trees processed the record pair consistently. If pair_consist is TRUE, the system 700 proceeds to step 727. Otherwise, the system 700 proceeds to step 728.

In step 727, the system 700 increments pair_index to signify that the system has completed processing the current record pair. Following step 727, the system 700 proceeds back to step 703.

In step 728, the system 700 assigns the record pair a preliminary label inconsistent. Following step 728, the system proceeds to step 727.

In accordance with another example system of the present invention, a computer program product may interactively learn a record similarity measurement. The product may include an input set of record clusters. Each record in each cluster may have a list of fields and data contained in each field. The product may further include a predetermined input threshold score for two of the records in one of the clusters to be considered similar and an input decision tree constructed from a portion of the set of clusters. The decision tree may encode rules for determining a field similarity score of a related set of fields. The product may further include an output set of record pairs that are determined to be duplicate records. The output set of record pairs has a record similarity score greater than or equal to the predetermined threshold score.

Another example system in accordance with the present invention may include a decision-tree based system for identifying duplicate records in a record collection (i.e., records referring to the same entity, etc.). The example system may use a similarity function encoded in a collection of decision trees constructed from an initial set of training data. The similarity function may be refined during an interactive session with a human user. For each record pair, resulting classification decisions from the collection of decision trees may be combined into a single numerical record similarity score.

This type of decision tree based system may provide a greater robustness to errors in the record collection and/or the assigned field similarity values. This robustness leads to higher accuracy than a simple linear combination of the field similarity values (i.e., the conventional weighted combination of field similarity values, etc). By building several decision trees over related fields, a high quality of the rules encoded by the system is achieved. The rules are more accurate and spurious results are avoided. Further, this decision tree based system may encode the matching rules for easy comprehension and evaluation. Also, the matching rules may be presented in a manner that non-technical, non-expert users may understand.

This example system may also identify ambiguous and conflicting record pairs in the created clusters. From these pairs, additional examples from an interactive session may provide the best information to a user. Based on user feedback from these new examples, the system may adjust the similarity function to improve accuracy on these hard cases (i.e., matching rules encoded in decision tree collection and/or how they are combined together, etc.).

Since this example system selects the training examples that provide the most pertinent information, a user only needs to manually assign labels to a relatively small number of examples while still achieving a high level of accuracy of the matching rules learned for the similarity function. Additionally, this selection also minimizes the burden on an expert user to select an initial complete training set.

From the above description of the invention, those skilled in the art will perceive improvements, changes and modifications. Such improvements, changes and modifications within the skill of the art are intended to be covered by the appended claims.

Having described the invention, the following is claimed:

1. A system for learning a record similarity measurement, said system comprising:
a set of record clusters, each record in each cluster having a list of fields and data contained in each said field;
a predetermined threshold score for two of said records in one of said clusters to be considered similar;
at least one decision tree constructed from a predetermined portion of said set of clusters, said decision tree encoding rules for determining a field similarity score of a related set of said fields; and
a set of record pairs that may be determined to be duplicate records, said set of record pairs each having a record similarity score determined by said field similarity scores, said record pairs having a record similarity score greater than or equal to said predetermined threshold score being determined to be duplicate records.

2. The system as set forth in claim 1 further including a select group of record pairs that are used to interactively determine the accuracy of said at least one decision tree.

3. The system as set forth in claim 2 wherein said select group of record pairs are outputted to a user for interactively determining the accuracy of said at least one decision tree.

4. The system as set forth in claim 3 wherein said similarity scores are modified by the user subsequent to the user reviewing said select group of record pairs.

5. The system as set forth in claim 4 wherein said system outputs a record similarity function improved by the input of the user.

6. The system as set forth in claim 5 wherein said system comprises part of a matching step in a data cleansing application.

7. The system as set forth in claim 1 wherein a record in at least one said record cluster has no record similarity score greater than or equal to said predetermined threshold score, said one record having data pertaining to an entity other than the other records in said record cluster.

8. A method for learning a record similarity measurement, said method comprising the steps of:
providing a set of record clusters, each record in each cluster having a list of fields and data contained in each field;
providing a predetermined threshold score for two of the records in one of the clusters to be considered similar;
providing at least one decision tree constructed from a portion of the set of clusters, the decision tree encoding rules for determining a field similarity score of a related set of fields;
determining a record similarity score from the field similarity scores; and
outputting a set of record pairs that are determined to be duplicate records, the output set of record pairs having a record similarity score greater than or equal to the predetermined threshold score.

9. The method as set forth in claim 8 further including the step of selecting a group of record pairs that are used to interactively determine the accuracy of the at least one decision tree.

10. The method as set forth in claim 8 further including the step of outputting the selected group of record pairs to a user for interactively determining the accuracy of the at least one decision tree.

11. The method as set forth in claim 8 further including the step of modifying the field similarity scores by the user subsequent to the user reviewing the selected group of record pairs.

12. The method as set forth in claim 8 further including the step of outputting a record similarity function improved by the input from the user.

13. The method as set forth in claim 8 wherein said method is conducted as part of a matching step in a data cleansing application.

14. A computer program product for interactively learning a record similarity measurement, said product comprising:
an input set of record clusters, each record in each cluster having a list of fields and data contained in each field;
an predetermined input threshold score for two of the records in one of the clusters to be considered similar;
an input decision tree constructed from a portion of the set of clusters, the decision tree encoding rules for determining a field similarity score of a related set of fields;
an output set of record pairs that are determined to be duplicate records, the output set of record pairs having a record similarity score greater than or equal to the predetermined threshold score; and
a set of record pairs determined to be non-duplicate records.

15. The computer program product as set forth in claim 14 further including a selected group of record pairs that are used to determine the accuracy of the decision tree.

16. The computer program product as set forth in claim 15 wherein the selected group of record pairs are outputted to a user for determining the accuracy of the decision tree.

17. The computer program product as set forth in claim 16 wherein the record similarity score is modified by the user subsequent to the user reviewing the selected group of record pairs.

18. The computer program product as set forth in claim 17 wherein said computer program product outputs a record similarity function improved by the input from the user.

19. The computer program product as set forth in claim 18 wherein said computer program product comprises part of a matching step in a data cleansing application.
